(19) United States
(12) Patent Application Publication
(10) Pub. No.: US 2012/0038778 A1
(43) Pub. Date: Feb. 16, 2012

(54) Self-Scanning Passive Infrared Personnel Detection Sensor

(75) Inventors: Gene A. Klager, Dumfries, VA (US); Joshua K. Gabonia, Woodbridge, VA (US); John E. Hutchison, III, Alexandria, VA (US); Harry W. McClellan, JR., Springfield, VA (US)

(73) Assignee: United States of America, as represented by the Secretary of the Army, Fort Belvoir, VA (US)

(21) Appl. No.: 12/854,512

(22) Filed: Aug. 11, 2010

(51) Int. Cl. H04N 5/33

(52) U.S. Cl. 348/166; 348/E05.09

(57) ABSTRACT

A system capable of low power personnel detection is based on a focused linear array of passive infrared detectors sampled and processed over time. For example, an exemplary system can have a sensor that captures infrared line images for personnel detection by scanning through a sensing plane of a linear array's field of view. In such a system, a processor controls the array sensor and stores the resulting images. Velocity characteristics of moving objects are incorporated into the images over time resulting in horizontal velocity profile images. Long wave infrared (LWIR) radiation can be sensed, which works in day and night conditions without illumination. LWIR sensors, such as microbolometers, as well as pyroelectrics, can be used.

### GOVERNMENT INTEREST

The invention described herein may be manufactured, used, sold, imported, and/or licensed by or for the Government of the United States of America.

### FIELD OF THE INVENTION

This invention relates in general to passive infrared sensing, and more particularly to self-scanning passive infrared personnel detection.

### BACKGROUND OF THE INVENTION

A variety of linear passive infrared arrays are commercially available that use far less power than the lowest power uncooled infrared cameras. The design, detection technologies and application of these linear arrays varies. Available for commercial sale, for example, is an eight element thermopile linear array made using a silicon substrate and a widely used type of temperature sensor called a thermocouple. These arrays are typically used in industrial temperature sensing, fire detection and microwave ovens. Thirty-two (32), 128 and 256 sensing element arrays made with pyroelectric materials such as lithium tantalate are available as well. Pyroelectric materials are crystals that develop charge when heated. The motion sensing capability of pyroelectric sensors is known to be power efficient. These arrays can typically be found in the fields of temperature measurement and spectrometry.

Current computer vision devices process full-frame visible light images to identify an object's shape. The type or classification of an imaged object is inferred by comparing the shape to known examples. However, this approach of processing full-frame light images is not suitable for low-power day and night personnel detection.

### SUMMARY OF THE INVENTION

The need for low power personnel detection is evident in security and border monitoring situations where an area must be monitored at all times. This calls for a system that will work in day and night conditions with low power consumption. Long wave infrared (LWIR) is virtually immune to the lighting conditions of a scene and can detect people based on their body heat, and therefore is optimal for day/night solutions. Algorithms that operate on a single column of LWIR pixels to classify horizontal velocity profiles have been developed, and due to the relatively small images they work on, they can be executed on low power processors in real time. Both statistics based and shape based algorithms have been demonstrated to work well with profiles.

An exemplary embodiment of a personnel detection sensor can be based on a complementary metal-oxide-semiconductor (CMOS) imager and horizontal velocity profiles to detect and classify personnel using velocity profile images.

In one exemplary embodiment, a self-scanning passive infrared personnel detection sensor system is disclosed. Such an exemplary sensor system comprises a lens to focus an infrared radiation from a scene; an array of passive thermal sensing elements as a sensor aligned behind said lens to output a sensor signal; and a processor connected to said sensor to control said sensor and read the sensor signal, the processor processing said sensor signal to assemble linear image frames based on said sensor signal output, and process noise filtering to reduce said linear image frames to a reduced form of binary image data, wherein said processor outputs velocity profile image signals based on said reduced form of binary image data for human detection by algorithmic processing.

In another exemplary embodiment, a self-scanning personnel detection process is disclosed based on a passive infrared detection sensor system having an array of sensing elements aligned as a sensor behind a lens. Such an exemplary personnel detection process comprises positioning said passive infrared detection sensor system above ground to point its sensing volume approximately perpendicular to the expected path of movement in an area to be monitored to capture sensor signals for detecting a person whose body passes through the sensing volume, wherein said passive infrared detection sensor system has a fan-shaped sensing volume through a lens; using a processor to construct columns of profile image signals in regular time intervals based upon the captured sensor signals from the array of sensing elements sensing a view of the person passing through the sensing volume, wherein different shade values in the columns represent different sensed intensities; processing the profile image signals by said processor to filter said profile image signals to reduce non-uniformity noise, wherein a vertical axis of the image signals is spatial and a horizontal axis of the image signals is temporal; and outputting the filtered profile image signals for personnel detection processing.

In yet another exemplary embodiment, a computer program-based personnel detection process is disclosed for execution by devices of a self-scanning sensor system including a processor device and an array of sensing elements aligned as a sensor behind a lens with a field of view. Such an exemplary process comprises power-up initializing the processor device to perform at least one of preparing variables and memory for operation, running diagnostics, starting the sensor component as necessary, and initializing communications with external devices; timing control to handle processor-device timing of critical elements for processing of sensor data, including control of time sample delay to achieve uniformly distributed sample timing; sensor data request by said processor device to said sensor for sensor data acquisition during a sensor integration period as timed by said timing control, wherein timing signals and parameters are provided to said sensor; acquiring sensor data, wherein said sensor receives a signal from the processor device to acquire said sensor data during a radiation integration time of the sensor; storing sensor data, wherein said processor device stores sensor data in processor memory upon receiving sensor data from said sensor component for algorithmic processing; and at least one of preprocessing and filtering of said sensor data in processor memory. Said sensor data is processed to perform at least one of filter sensor data, correct non-uniformity in sensor data, and apply a binarization algorithm to said sensor data, wherein one or more of said process steps can be executed in parallel.

Such exemplary sensors can find use in difficult environments, e.g., in areas where power infrastructure is not available. Such an exemplary sensor can be battery operated, yet provide a long lifetime to be practical, particularly in difficult or remote terrain. Such a system can be configured to be in a low power idle state most of the time, e.g., running detection algorithms only when the system detects significant change.

### BRIEF DESCRIPTION OF THE DRAWINGS

Additional advantages and features will become apparent as the subject invention becomes better understood by reference to the following detailed description when considered in conjunction with the accompanying drawings wherein:

FIG. 1 shows an exemplary arrangement of an array of passive thermal sensing elements aligned behind a lens with a processor that controls and reads the sensor array;

FIG. 2 shows an exemplary sensor system detecting a person passing through a sensing volume;

FIG. 3 shows an exemplary profile collected by an exemplary sensor system of a person walking by the sensor twice; and

FIG. 4 shows an exemplary process flow for sensor detection.

### DETAILED DESCRIPTION

An exemplary system capable of low power personnel detection is based on a focused linear array of passive infrared detectors sampled and processed over time. Personnel detection here is defined as determining whether a human is in the sensor's field of view. Self scanning indicates that the motion of the sensed objects is used to detect the entire object as it moves through the sensor's field of view.

An exemplary system has a sensor that captures infrared line images. Such a system output can be applied to algorithmic processing, e.g., for personnel detection. The system senses objects that self scan by moving through the sensing plane of a linear array's field of view. The field of view of the array is the projection of the array through the lens, which defines the area where the system detects objects. The linear array is a sequence of closely spaced sensing elements equivalent to a single column of a traditional two-dimensional focal plane array. The system has a processor that controls the array sensor and stores the images.

The single array of sensing elements consumes lower power to process this correspondingly smaller amount of data. Due to the self scanning nature of the sensor, the velocity characteristics of moving objects are incorporated into the images over time resulting in horizontal velocity profile images, e.g., essentially sequences of line images of the same space with a set time constant between them. Such an exemplary sensor senses long wave infrared (LWIR) radiation, which can work in day and night conditions without illumination. LWIR sensors, such as microbolometers, as well as pyroelectrics can be used.

To achieve very low power personnel detection day or night, an exemplary system integrates a linear array of infrared detectors with an infrared lens for minimal processing. Modifying uncooled infrared (IR) cameras and image processors to reduce power consumption to an acceptable level (in comparison to single array sensors) is problematic and prohibitively expensive. In contrast, by using a linear array of infrared detectors, the overhead required to run an uncooled IR camera is eliminated, thereby significantly reducing power consumption. The processing power required to analyze a column of pixels is much less than that required for a full IR image, further reducing power demand. The result is a very low power, low cost detector capable of discriminating personnel from other targets.

Alternatively, an exemplary embodiment of a personnel detection sensor can be based on a complementary metal-oxide-semiconductor (CMOS) imager and horizontal velocity profiles to detect and classify personnel using velocity profile images. A single vertical line of the CMOS imager's focal plane array was sampled at a steady rate as a person moved through the imager's FOV. Parallel processing done by very low power microcontrollers removed stationary and pseudo-motion background elements, exploited the moving object's velocity characteristics and created the object's “signature”, that is, its horizontal velocity profile. Processors then compared the object's signature to a catalog of horizontal velocity profile signatures to classify the object as human or not. Such an exemplary sensor requires minimal power and computing resources yet can differentiate between vehicles, quadrupeds and humans.

Such an exemplary sensor is intended for security and monitoring applications, so it is expected to be integrated with a system that processes the images generated to detect personnel. Such an exemplary sensor can be interfaced to integrate with other systems by any systems interface. In one aspect, such a sensor can be thought of as a special purpose camera optimized for personnel detection and low power operation. The output of the sensor is a sequence of linear images, which are stored in memory and made available on an electronic interface for processor to processor communication. The input to the sensor is the infrared radiation of the scene focused through the lens.

Exemplary Features and Advantages:

Exemplary features as variously disclosed are highlighted as salient features below.

a. Combining a linear array passive infrared detector with narrow field of view optics facilitates long range detection with low power consumption during day or night operations.

b. Providing a compact velocity profile image as the output of a sensor system. This type of image can be processed efficiently and offers the further advantage of facilitating bandwidth efficient transmission of low resolution images if desired.

c. Providing memory and processor capacity on the system processor for the user to enter algorithms to be executed on the data as it is captured. This allows the system to operate as a test bed for algorithm development or as a full real time personnel detection sensor.

d. Use of a linear array of passive infrared detectors focused with a lens, target self-scanning, use of low power microcontrollers to capture a horizontal velocity image, providing processing and memory capacity for algorithm execution on the same processor that interfaces with the sensor, and/or combining a sensor optimized for velocity profiles with a battery and low power processor.

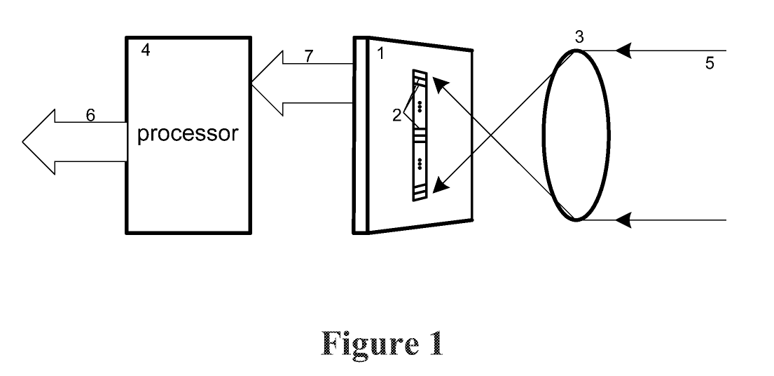

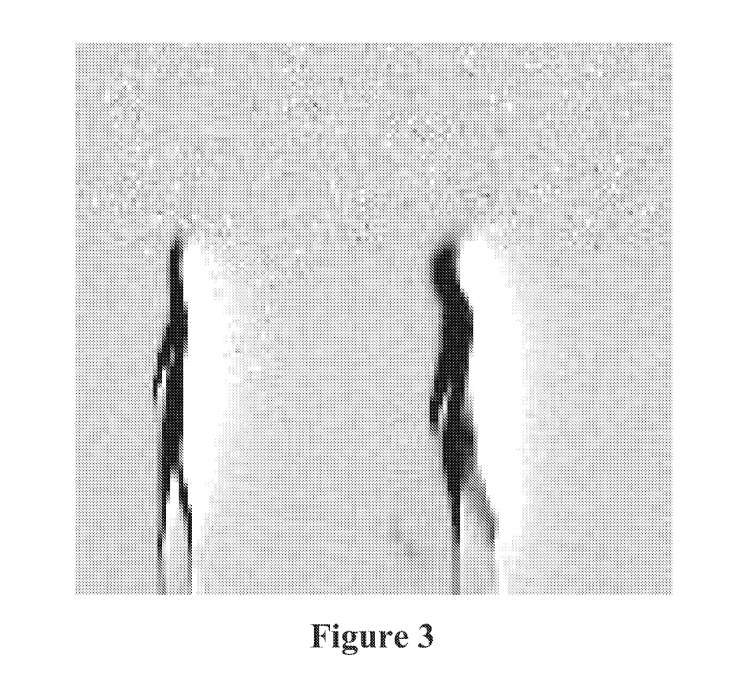

Referring to FIG. 1, an exemplary system is comprised of an array (1) of passive thermal sensing elements (2) aligned behind a lens (3) with a processor (4) that controls and reads the sensor array and prepares profiles for human detection algorithms. The connection between 1 and 4 is a data bus (7) that carries control signals from the processor (4) to the sensor (1) and scene data from the sensor to the processor. The input to the system is the infrared radiation of the scene (5) focused through the lens (3). The output of the system (6) consists of the velocity profile images as filtered by the processor and system status information. The output is available as data on an electronic data bus (6). The processor (4) is the component that initially assembles the linear image frame and carries out some noise filtering steps and reduces it to a minimal form (binary image). The processor (4) also provides the ability to run detection and discrimination algorithms on images as they are collected. Example algorithms are openly available for incorporation as a part of the system. An example profile collected by an exemplary sensor system with 128 sensing elements is shown in FIG. 3. This image shows a person walking by the sensor twice.

Operation

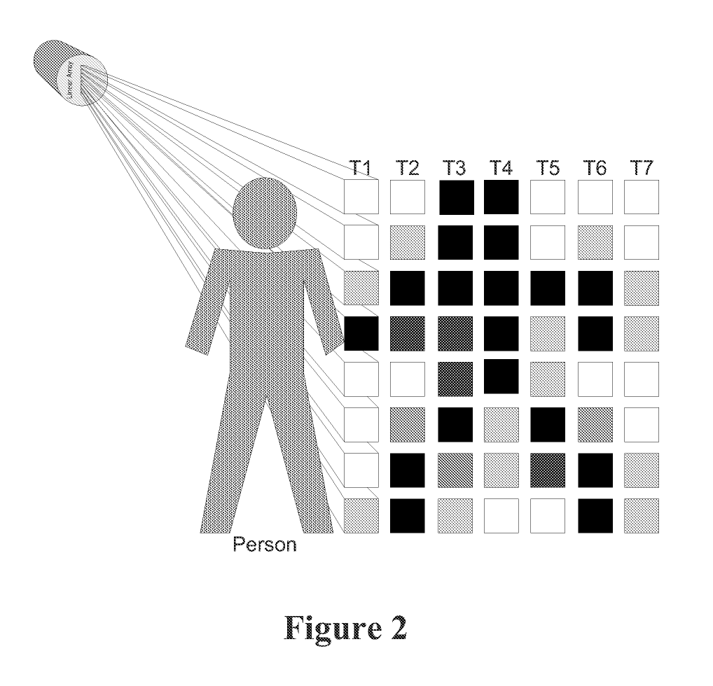

Such an exemplary system can be positioned roughly parallel to the ground pointing approximately perpendicular to the expected path that people will take through the area to be monitored as shown in FIG. 2. The sensing volume of the system is a fan shape defined by the projection of the array of sensing elements through the lens. The system is capable of detecting a person whose body passes through the sensing volume (up to a maximum sensing distance determined by the transmission characteristics of infrared radiation through the environment and lens, the sensitivity of the sensing elements and the individual fields of view of the sensing elements). To differentiate a person from animals and other objects that may move through the sensing plane, the system requires multiple sensing elements (see FIG. 2 for an eight element example). Operation of the system assumes that people to be detected will cross through the sensing volume roughly perpendicular to the sensing axis. FIG. 2 depicts a scenario where an eight element sensor system captures the profile of a person passing through the sensing area from right to left. A simulated profile is shown next to the person. Note that each column shown is from a different time period and that T1 is the oldest sensor reading and T7 is the most recent. Note also that the different shades in the columns represent different sensed intensities. The system processor is responsible for filtering this data so that it is prepared for detection algorithms. The sample image shown in FIG. 3 is data from an exemplary sensor system filtered to reduce non-uniformity noise. The vertical axis of the image is spatial and the horizontal axis is temporal, with older lines to the left and the most recent on the right. This type of data can be used as input to personnel detection algorithms.

Process Flow

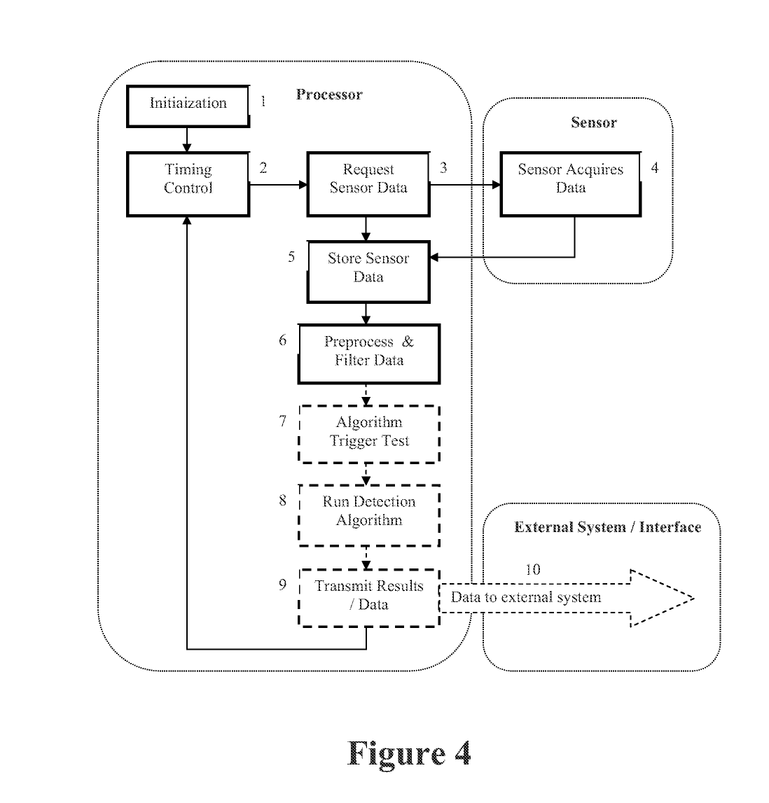

The system relies on software to carry out the intended functions. The process flow for the software is described in this section and depicted in FIG. 4. Some portions of the process are optional, since they are unnecessary in some operating conditions. This allows the system to operate in different modes, such as data logging, live sensor and stand alone personnel detector. The optional steps are numbers 7-10 in FIG. 4 and are shown with dashed outlines. The process blocks are described in the following subsections. It should be noted that some of these blocks are capable of running simultaneously and are therefore not limited to strictly sequential execution. Process 4 takes place in the sensor component and process 10 requires the cooperation of an external device. All other process reside entirely on the processor.

1) Initialization: this is the first step executed when the system is powered. It prepares variables and memory for operation, runs diagnostics, starts the sensor component (if necessary) and initializes communications with external devices. This step also starts the rest of the system when required, whether it is triggered by user input, a time delay or an external device (such as a computer).

2) Timing Control: this process handles timing critical elements, primarily the delay between samples (analogous to frame rate in video cameras). This allows samples to be uniformly distributed in time. This process is also responsible for ensuring that the optional steps 7-10 do not interfere with the timing of sensor data.

3) Request Sensor Data: this step is started by process 2 and interfaces with the sensor (via the electronic interface between the sensor and processor). Depending on the requirements of the sensor, it will provide timing signals and parameters as needed in addition to starting the sensor integration period. This process ends when a full array of data is received from the sensor. If the sensor requires constant timing input, this process will run nearly constantly, and it will only synch with the timing control process (2) so that data is available at the appropriate time in the sequence

4) Sensor Acquires Data: this step begins when a signal is received from the processor and takes place entirely on the sensor and encompasses the radiation integration time of the sensor. At the end of the process, data from the full array is transmitted to the processor. This process runs concurrently with process 3, as signals from the processor are generally required throughout acquisition and transmission.

5) Store Sensor Data: this process begins when sensor measurement data is received from the sensor component. The data is then stored in processor memory so that it will be ready for any algorithms to follow. This process can also save to non-volatile memory, which allows the system to act as a data logger.

6) Preprocess and Filter Data: this step starts when all data is available in processor memory and applies common filters to the data, such as non-uniformity correction. It is also allows additional user filters, such as binarization algorithms, to be run on the data.

7) Algorithm Trigger Test: this step executes after process 6 and checks the new data to determine if full detection algorithms should be executed. This is a power saving method. This process is optional and triggers process 8.

8) Run Detection Algorithm: this step is optional and executes on new and previous data when triggered by process 7. It runs personnel detection algorithms as entered by the user to determine whether a person is in the sensor's field of view.

9) Transmit Results/Data: this step runs after the last active data process, which can be 6 (if 7 or 8 are disabled), 7, or 8. This process is optional and transmits the results or processed data. Transmission can be to a destination on the processor or an external system, as desired by the user.

10) Data to external system: this step runs in conjunction with process 10 and contains the interface information and capability to transmit data to external devices. An example would be a USB module for communication with a computer.

It is obvious that many modifications and variations of the present invention are possible in light of the above teachings. It is therefore to be understood that within the scope of the appended claims, the invention may be practiced otherwise than as described.

What is claimed is:

1. A self-scanning passive infrared personnel detection sensor system, comprising:
a lens to focus an infrared radiation from a scene;
an array of passive thermal sensing elements as a sensor aligned behind said lens to output a sensor signal; and
a processor connected to said sensor to control said sensor and read the sensor signal, the processor processing said sensor signal to assemble linear image frames based on said sensor signal output, and process noise filtering to reduce said linear image frames to a reduced form of binary image data, wherein said processor outputs velocity profile image signals based on said reduced form of binary image data for human detection by algorithmic processing.

2. The system according to claim 1, wherein said processor outputs filtered velocity profile image signals.

3. The system according to claim 1, wherein said processor is connected to said sensor by an electronic data bus to send control signals from said processor to said sensor, and to send scene data from said sensor to the processor, and wherein said sensor is either a CMOS-based sensor or an LWIR sensor based on microbolometers or pyroelectrics.

4. The system according to claim 1, wherein said noise filtering by said processor uses system status information to produce said velocity profile image signals for output of data on an output electronic data bus.

5. The system according to claim 1, wherein said processor processes detection and discrimination algorithms on image data as collected.

6. A self-scanning personnel detection process based on a passive infrared detection sensor system having an array of sensing elements aligned as a sensor behind a lens, said personnel detection process comprising:
positioning said passive infrared detection sensor system above ground to point its sensing volume approximately perpendicular to the expected path of movement in an area to be monitored to capture sensor signals for detecting a person whose body passes through the sensing volume, wherein said passive infrared detection sensor system has a fan-shaped sensing volume through a lens;
using a processor to construct columns of profile image signals in regular time intervals based upon the captured sensor signals from the array of sensing elements sensing a view of the person passing through the sensing volume, wherein different shade values in the columns represent different sensed intensities;
processing the profile image signals by said processor to filter said profile image signals to reduce non-uniformity noise, wherein a vertical axis of the image signals is spatial and a horizontal axis of the image signals is temporal; and
outputting the filtered profile image signals for personnel detection processing.

7. The self-scanning personnel detection process according to claim 6, wherein said sensor is based on a CMOS imager in which a single vertical line of the CMOS imager's focal plane array is sampled at a steady rate as a person moves through the imager's field of view to allow system capability to use horizontal velocity profiles to detect and classify personnel passing through the sensing volume.

8. The self-scanning personnel detection process according to claim 6, wherein said fan-shaped sensing volume has a maximum sensing distance based on transmission characteristics of an infrared light radiating from the environment through lens, the sensitivity of the sensing elements and the individual fields of view of the sensing elements.

9. The self-scanning personnel detection process according to claim 6, wherein said sensor is an LWIR sensor based on microbolometers or pyroelectrics, and wherein said array of sensing elements has eight or more sensing elements to allow differentiation of a person from animals and other objects that may move through its sensing plane.

10. The self-scanning personnel detection process according to claim 6, wherein said people passes through the sensing volume roughly perpendicular to a sensing axis.

11. A computer program-based personnel detection process for execution by devices of a self-scanning sensor system including a processor device and an array of sensing elements aligned as a sensor behind a lens with a field of view, said process comprising:
power-up initializing the processor device to perform at least one of preparing variables and memory for operation, running diagnostics, starting the sensor component as necessary, and initializing communications with external devices;
timing control to handle processor-device timing of critical elements for processing of sensor data, including control of time sample delay to achieve uniformly distributed sample timing;
sensor data request by said processor device to said sensor for sensor data acquisition during a sensor integration period as timed by said timing control, wherein timing signals and parameters are provided to said sensor;
acquiring sensor data, wherein said sensor receives a signal from the processor device to acquire said sensor data during a radiation integration time of the sensor;
storing sensor data, wherein said processor device stores sensor data in processor memory upon receiving sensor data from said sensor component for algorithmic processing; and
at least one of preprocessing and filtering of said sensor data in processor memory, wherein said sensor data is processed to perform at least one of filter sensor data, correct non-uniformity in sensor data, and apply a binarization algorithm to said sensor data, wherein one or more of said process steps can be executed in parallel.

12. The process according to claim 11, wherein said sensor data request process step either ends when sensor data from the full array of sensing elements is received from said sensor, or if the sensor requires constant timing input, said sensor data request process step runs nearly continuously, and wherein said timing control step is used to synchronize availability of sensor data in sequenced time intervals.

13. The process according to claim 11, wherein sensor data from the full array of sensing elements is transmitted to said processor device upon said acquiring of sensor data, and wherein said sensor acquiring of sensor data runs concurrently with said sensor data request process step by said processor device, as control signals from the processor device are generally needed for acquisition and transmission of sensor data.

14. The process according to claim 11, comprising a power saving step based on an algorithm trigger test to check new sensor data to determine if a full detection algorithm should be executed by said processor device.

15. The process according to claim 14, comprising processing a detection algorithm by said processor device to execute on new and previous sensor data when triggered by said algorithm trigger test, wherein a personnel detection algorithm is invoked to perform at least one of removing of stationary and pseudo-motion background elements, exploit a detected object's velocity characteristics to create the object's horizontal velocity profile, compare the object's horizontal velocity profile to a catalog of horizontal velocity profile signatures, and classify the object to determine whether the detected object is a human or not to determine whether a person is in the sensor's field of view.

16. The process according to claim 11, comprising transmitting said preprocessed or filtered sensor data as output data from said processor device to any one of a receiving device or memory, another processor device or process, an external system, or a user operated device or interface.

17. The process according to claim 11, comprising transmitting data to an external system, wherein said data transmission is via a USB interface or other data interface for communication with a computer.

18. The process according to claim 11, wherein the power-up initialization step also starts the rest of the system and/or external devices as required, as triggered by user input, and/or based on a time delay or an external computing device.

19. The process according to claim 11, wherein said array of sensing elements is configured as a self-scanning passive infrared personnel detection sensor.

20. The process according to claim 11, comprising storing sensor data in a non-volatile memory, whereby said self-scanning sensor system is capable of data logging.
